(19) United States
(12) Patent Application Publication
(10) Pub. No.: US 2016/0191653 A1
(43) Pub. Date: Jun. 30, 2016

(54) ONLINE NETWORKING PLATFORM FOR EVENT CREATION MANAGEMENT AND PARTICIPATION

(71) Applicant: Stage Gator LLC, San Marcos, TX (US)

(72) Inventor: Nicholas Aluotto, San Marcos, TX (US)

(21) Appl. No.: 14/861,258

(22) Filed: Sep. 22, 2015

(51) Int. Cl. H04L 29/08; G06Q 10/10; G06Q 50/00; H04L 12/58

(52) U.S. Cl. CPC H04L 67/30; H04L 67/02; H04L 51/04; G06Q 10/1095; G06Q 50/01

(57) ABSTRACT

The method comprises creating a profile and linking the networking websites to the profile. The created profile is segregated as a “Venue” and a “Performer”. The venue holds ownership of a place for conducting an event. The venue creates an event or receives a request for an event to be hosted on the venue. The venue finalizes the events and sends a plurality of invitations to the performers and attendees. The venue also posts the event details over the linked networking websites. The venue also receives requests from a plurality of performers to perform at one or more events. The venue selects the list of performers to be performing at a specific event. The venue also finalizes a list of attendees attending the specific event. On the day of event, the venue and the performers dynamically receives updates of the attendees, the performances according to the event timelines.

### BACKGROUND

1. Technical Field of Invention

The embodiments herein generally relate to an online networking platform and particularly relates to an online platform for event creation, management and participation. The embodiments herein more particularly relate to an online platform for creating an event on small to large scale, inviting and managing the performers and sending an invitation to various networking websites.

2. Description of Related Art

An event management is the application of project management to the creation and development of large scale events such as festivals, conferences, ceremonies, formal parties, concerts, or conventions. It involves studying the brand, identifying the target audience, devising the event concept, planning the logistics and coordinating the technical aspects before actually launching the event. The event management is not getting digitalized via a social networking sites to attract large media. The social networking service (also social networking site or SNS) is a platform to build social networks or social relations among people who share similar interests, activities, backgrounds or real-life connections. The social network service consists of a representation of each user (often a profile), his or her social links, and a variety of additional services. The social network sites are web-based services that allow individuals to create a public profile, create a list of users with whom to share connections, and view and cross the connections within the system. Most social network services are web-based and provide means for users to interact over the Internet, such as e-mail and instant messaging. Social networking sites are varied and they incorporate new information and communication tools such as mobile connectivity, photo/video/sharing and blogging. The online community services are sometimes considered a social network service, though in a broader sense, social network service usually means an individual-centred service whereas online community services are group-centred. The social networking sites allow users to share ideas, pictures, posts, activities, events, and interests with people in their network.

One of the prior art discloses a user customizable, real-time, online merchant event platform utilizes price variations through at least one sales event for increasing website visibility. The platform includes a user interface configured to input: sale item identification, sale event duration for each sale item, a sale item price range, and a frequency distribution identifying the relationship of the price range and the associated sale items and the duration of the associated sales event. The merchant event platform generates a frequency distribution database utilizing the frequency distribution to identify the price of each sale item during the sales event. The merchant event platform includes at least one online web page displaying select sale item indicia, a price range for the sales items, a current price for an associated sale item, purchasing indicia for a sale item configured to facilitate consumer purchase of the associated sale item, and user related advertising indicia.

Another prior art discloses an event management system which is implemented on a hosted platform. The hosted platform comprising a front end portal including at least one user interface; an administrative portal through which third parties access the hosted platform; at least a search engine interfacing with said front end portal for carrying out searches in accordance with parameters input by a user through the front end portal; a plurality of modules each comprising an application associated with event management; and a back end interfacing with said search engine and each module by way of a connection hub to provide application integration.

Yet another prior art discloses a system for the planning, management and execution of events that permits the event manager, client, convention personnel, and suppliers to coordinate activities and rapidly disseminate information. Preferably, the system includes a repository of information. All or some portions of the information may be electronically accessed by the various parties, subject to the limitations imposed by the event manager. A real time information is provided to the parties, including the ability to observe the progress of the production of the exhibit in real time from remote locations.

However, the conventional event management systems and methods provide access to an event creation and management including date and time of performance, a venue selection and sending an invitation to a viewer. The conventional event management system fails to allow a venue (managed by a personnel) to host an event of preferred choice and invite preferred participants. Also, the conventional event management systems and methods fail to reach out to a large number of local as well as global performers resulting in lack of a platform for a local performer. Further, prior art's event management system lacks in automating an event on the basis of a choice of a venue as well as a performer.

In the view of foregoing, there is a need for an online platform for an event management allowing accessibility to local as well as global performer. Also there is a need for an event management platform to send an invitation to a large no. of participants through various social and professional networking websites. Further there is a need for an event management platform to provide event management capabilities to an event manager, a venue manager and a participant.

The above mentioned shortcomings, disadvantages and problems are addressed herein, as detailed below.

### SUMMARY OF THE INVENTION

The primary object of the embodiments herein is to provide an online platform for an event management allowing accessibility to local as well as global performer.

Another object of the embodiment herein is to provide an event management platform to send an invitation to a large no. of participants through various social and professional networking websites.

Yet another object of the embodiments herein is to provide an event management platform to provide event management capabilities to an event manager, a venue manager and a participant.

Yet another object of the embodiments herein is to provide an online event management platform with performer ranking facility.

Yet another object of the embodiments herein is to provide an online event management platform with real time notifications pertaining to an event and a plurality of the performers' activities participating the event.

The various embodiments herein provides a method for an online event management platform with a real time performer and attendance management provided to a venue of an event. The method comprises creating a profile on the online event management platform and linking at-least one networking website to the created profile. The venue log into the online platform directly through a newly created login ID and password or through the linked networking website. A specific uniform resource locator (URL) is automatically created for the created profile. The venue manages a date, time and a plurality of details of an event over the specific URL. The venue sends an invitation to a plurality of performers and performance attendees through the online platform and the at-least one linked networking website. The venue also manages a request received from a performer to perform at an event. The online platform blocks a time slot, the performers and the attendees for an event prior to a commencement of the event happening over the venue on a predetermined. The venue receives a real time notification of an event. The real time notification comprises a message in an inbox, a performer's action in reply to a sent invitation, an application from a performer for an event, a pending ranking notification and an attendee action over an invitation or request to join the event.

According to one embodiment herein, the venue manages the created profile over the online platform. The online platform works over a system comprising a primary computing device, a central server and a plurality of secondary computing devices. The primary computing device is implemented to create an event. The central server is a remote hosting device further comprising a memory unit, an analytical module and a notification segregator. The memory unit holds a plurality of profile data and a plurality of event data. The analytical module manages invitations sent in the event, timing of the event and a list of attendees and performers. The notification segregator stores and transmits a real time notification as well as segregates a notification in various categories. The plurality of secondary computing devices are connected to the central server. The attendees accept an invitation or send a request for the event through the plurality of the computing devices.

According to one embodiment herein, a plurality of event styles are selected by the venue, wherein the plurality of event styles comprises a cultural event, a historical event, a national event, a concert and a gaming event.

According to one embodiment herein, the central server marks an attendance in an event and ranks a performer on the basis of a response of the attendees.

The embodiments herein provides a method for an online event management platform with a real time attendance and venue management provided to a performer of an event. The method comprises creating a profile on the online event management platform and linking at-least one networking website to the created profile. The venue log into the online platform directly through a newly created login ID and password or through the linked networking website. A specific uniform resource locator (URL) is automatically created for the created profile. The venue manages a date, time and a plurality of details of an event over the specific URL. The performer sends a request to a venue for participating in an event or organizing an event. The venue manages the request received from the performer as well as a list of attendees. The venue blocks a time slot, the performers and the attendees for an event prior to a commencement of the event. The performer receives real time notification of an event. The real time notification comprises a message in an inbox, a performer's action in reply to a sent invitation, an application from a performer for an event, a ranking notification, a trading status, a time slot change for an event and an attendee action over an invitation or request to join the event.

According to one embodiment herein, the performer manages a trading request received from or sent to a plurality of performers through the online platform.

According to one embodiment herein, the central server marks an attendance in an event and ranks the performer on the basis of a response of the attendees.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 is a flowchart showing the method for an online event management platform with a real time performer and attendance management provided to a venue of an event, according to an embodiment herein.

FIG. 2 illustrates a login page of the online event management platform, according to an embodiment herein.

### DETAILED DESCRIPTION OF THE DRAWINGS

In the following detailed description, a reference is made to the accompanying drawings that form a part hereof, and in which the specific embodiments that may be practiced is shown by way of illustration. The embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments herein provide a method for an online event management platform with a real time performer and attendance management provided to a venue of an event. The method comprises creating a profile on the online event management platform and linking at-least one networking website to the created profile. The venue log into the online platform directly through a newly created login ID and password or through the linked networking website. A specific uniform resource locator (URL) is automatically created for the created profile. The venue manages a date, time and a plurality of details of an event over the specific URL. The venue sends an invitation to a plurality of performers and performance attendees through the online platform and the at-least one linked networking website. The venue also manages a request received from a performer to perform at an event. The online platform blocks a time slot, the performers and the attendees for an event prior to a commencement of the event happening over the venue on a predetermined. The venue receives a real time notification of an event. The real time notification comprises a message in an inbox, a performer's action in reply to a sent invitation, an application from a performer for an event, a pending ranking notification and an attendee action over an invitation or request to join the event.

According to one embodiment herein, the venue manages the created profile over the online platform. The online platform works over a system comprising a primary computing device, a central server and a plurality of secondary computing devices. The primary computing device is implemented to create an event. The central server is a remote hosting device further comprising a memory unit, an analytical module and a notification segregator. The memory unit holds a plurality of profile data and a plurality of event data. The analytical module manages invitations sent in the event, timing of the event and a list of attendees and performers. The notification segregator stores and transmits a real time notification as well as segregates a notification in various categories. The plurality of secondary computing devices are connected to the central server. The attendees accept an invitation or send a request for the event through the plurality of the computing devices.

According to one embodiment herein, a plurality of event styles are selected by the venue, wherein the plurality of event styles comprises a cultural event, a historical event, a national event, a concert and a gaming event.

According to one embodiment herein, the central server marks an attendance in an event and ranks a performer on the basis of a response of the attendees.

The embodiments herein provide a method for an online event management platform with a real time attendance and venue management provided to a performer of an event. The method comprises creating a profile on the online event management platform and linking at-least one networking website to the created profile. The venue log into the online platform directly through a newly created login ID and password or through the linked networking website. A specific uniform resource locator (URL) is automatically created for the created profile. The venue manages a date, time and a plurality of details of an event over the specific URL. The performer sends a request to a venue for participating in an event or organizing an event. The venue manages the request received from the performer as well as a list of attendees. The venue blocks a time slot, the performers and the attendees for an event prior to a commencement of the event. The performer receives real time notification of an event. The real time notification comprises a message in an inbox, a performer's action in reply to a sent invitation, an application from a performer for an event, a ranking notification, a trading status, a time slot change for an event and an attendee action over an invitation or request to join the event.

According to one embodiment herein, the performer manages a trading request received from or sent to a plurality of performers through the online platform.

According to one embodiment herein, the central server marks an attendance in an event and ranks the performer on the basis of a response of the attendees.

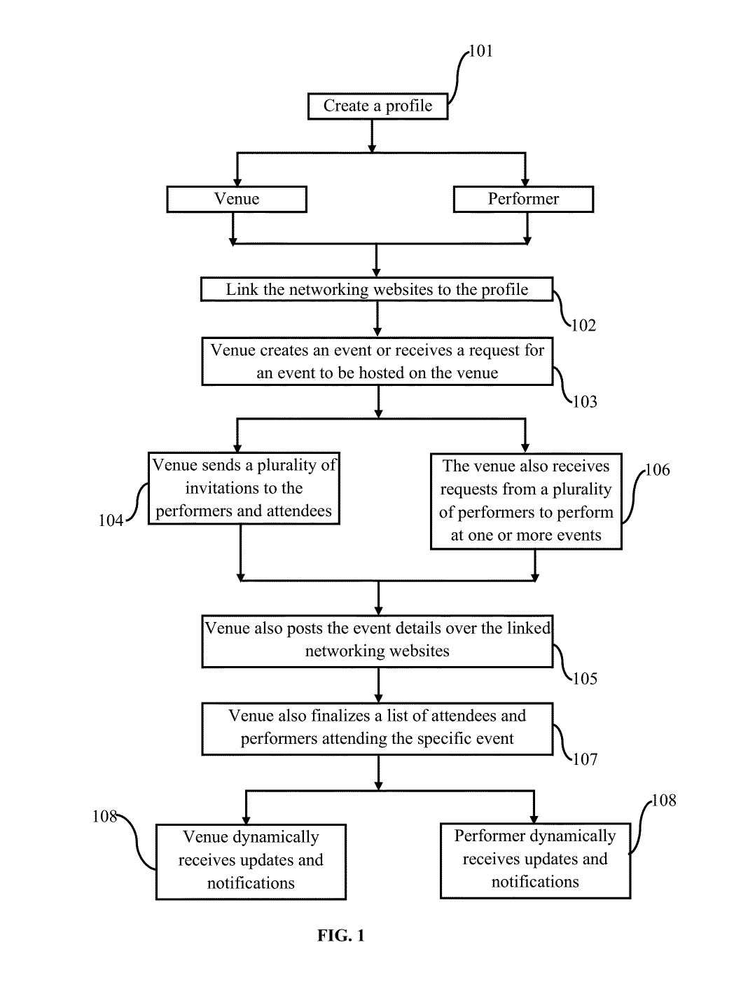

FIG. 1 is a flowchart showing the various steps involved in the method for an online event management platform with a real time performer and attendance management provided to a venue of an event, according to an embodiment herein. With respect to FIG. 1, the method comprises creating a profile (101) and linking the networking websites to the profile (102). The created profile is segregated as a “Venue” and a “Performer”. The venue holds ownership of a place for conducting an event. The venue creates an event or receives a request for an event to be hosted on the venue (103). The venue finalizes the events and sends a plurality of invitations to the performers and attendees (104). The venue also posts the event details over the linked networking websites (105). The venue also receives requests from a plurality of performers to perform at one or more events. The venue selects the list of performers to be performing at a specific event (107). The venue also finalizes a list of attendees attending the specific event (107). On the day of event, the venue and the performers dynamically receives updates of the attendees, the performances according to the event timelines (108).

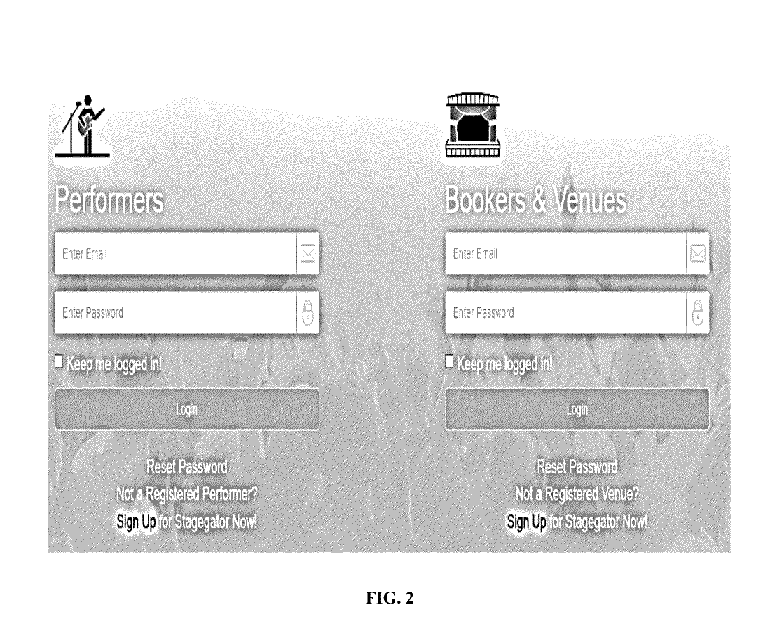

FIG. 2 illustrates a login page of the online event management platform, according to an embodiment herein. With respect to FIG. 2, the login page of the online event management platform allows a user to register as a performer or a host, or venue. After successful registrations, the performer and the venue account details are primarily kept anonymous with each other with exceptions in few overlapping domains to share an event information and exchange a participation request as well as invitation.

According to an embodiment herein, the workflow of an event management platform is categorized as:

### Venue:

A user tagged or referred as venue performs the following actions:
A. Create Venue Profile (From the Sign Up Page)
B. Login
   1. Using Website Account
   2. Facebook
   3. Twitter
C. Edit/Update Profile
D. Set the Custom URL for the Profile: this is the Direct URL to view your profile at a home. For example if a user set james-brown in the URL while updating the profile then his profile is directly viewed at http://stagegator.com/james-brown. By default, a unique number is allotted as Custom URL to the profile which the user changes as per his or her preference.
E. Change Password
F. Change Profile Image
G. Create Event: While creating/editing the event a venue can only select event style from the list of style he has added in his profiles.
H. Manage Events: the event management contains the following options:
   a. View Event Details
   b. Edit Event
   c. View Performers
      i. See the list of all the performers performing in the event
      ii. Rank Performer
      iii. Mark Attendance
   d. Manage Event Schedule
      i. Venue can always change the event schedule, List of all the performers who are performing in the event and are not assigned a time slot are available in the dropdown. Venue can reset the time slot of any performer and assign some other slot to it
   e. Delete Event
   f. Sent Bulk invitations to the Performers
I. Accept Performance for the events: In this section venue can view all the performer's requests to perform in any event, venue has the right to approve or reject this request.
J. Performance Invites: In this section venue can view all the invites sent to the performers to perform in a specific event.
K. Host Invites: This section is divided into following two sub-sections:
   a. New Invite: From this section, the venue is able to invite any performer from hosting an event.
   b. Manage Invites: In this section, the venue is able to see the list of invitations sent to all the performers, the current status of invitation and if the invitation is being accepted by the performer then the venue has an option to assign access rights to the performer i.e. the performer performs being a host of the event.
   c. Dynamic Access Rights for the Host: Venue assigns the access rights to the host dynamically.
L. Search Performer: Venue can search for the performers based on style and city, and also invite any performer to perform in any of their upcoming event.
M. My Inbox
   a. View Inbox
   b. View Outbox
   c. Send New Message
      i. A venue can send message to any performer registered in the system
   d. Delete Message (Inbox/Outbox)
   e. Reply Any Message
N. My Subscriptions: In this section a venue can see the list of payments made to the online platform and can also make a new payment.
O. My Events: In this section venue is able to see the list of its upcoming events moreover venue can navigate to the following screens form this area:
   a. Schedule: In this section, venue is able to see the schedule of the event, venue have the full access over the schedule i.e. venue can change the time slot of any performer and re-arrange the complete schedule.
   b. Performers: In this section venue is able to see the list of performers for the selected event. Further from this screen a venue can perform the following tasks:
      i. Mark Performer's Attendance
      ii. Rank Performer's Performance
P. Real Time Notifications: The system generates real time notifications for the following
   a. New Message in the inbox
   b. Performer's Action on any invite sent to him/her
   c. Any performer apply to perform in an upcoming event
   d. Any action performed against host invitation
   e. Pending Ranking Notification
Q. Email Notifications:
   a. New Message in the inbox
   b. Performer's Action on any invite sent to him/her
   c. Any performer apply to perform in an upcoming event
   d. Any action performed against host invitation
   e. Pending Ranking Notification
   f. Recursive event added in an Event List
   g. Display Picture is missing
R. Help Page
S. Settings
   a. Turn On/Off Email notifications
   b. Turn On/Off receiving On-site messages
T. Site-wise Option Description Added (Show Option Description on “?”)

### Performer:

A user tagged or referred as performer performs the following actions:
A. Create Performer Profile (From the Sign Up Page)
B. Login
   a. Using Website Account
   b. Facebook
   c. Twitter
C. Edit/Update Profile
D. Set the Custom URL for the Profile: this is the Direct URL to view your profile at a home. For example if a user set james-brown in the URL while updating the profile then his profile is directly viewed at http://stagegator.com/james-brown. By default, a unique number is allotted as Custom URL to the profile which the user changes as per his or her preference.
E. Change Password
F. Change Profile Image
G. Awaiting Approval from the venue: In this section a performer views all the events for which he has applied for and the response from venue on his application.
H. Manage Performance Request: In this section a performer will see all the invitations by difference venues to perform on any of their event. The performer has the right to accept or reject any invitation.
I. Trading Requests: In this section, a performer will be able to see the list of trading requests the received or sent to any performer, User can perform the following tasks from this screen:
   a. Approve Trading Request.
   b. Accept Trading Request.
   c. See the Status of Requests.
J. Host Invites: In this section performer will be able to see all the host invitation he/she received from any venue and can perform the following operations from this screen:
   a. Accept Host Invitation
   b. Reject Host Invitation
K. Search Event: A performer can search for any event bases on name, style and city, he/she can also apply for any event from the search results.
L. My Inbox
   a. View Inbox
   b. View Outbox
   c. Send New Message
      i. A venue can send message to any performer registered in the system
   d. Delete Message (Inbox/Outbox)
   e. Reply Any Message
M. My Events: In this section a performer views the list of upcoming events in which he/she will be performing, a performer can perform the following actions from this screen
   a. Manage Schedule
      i. Performer can select any timeslot available for his performance
      ii. Host (Only if a he/she is the host of the event): As a host performer will have the access options as assigned by the venue
N. My Subscriptions: In this section, a venue can see the list of payments made to the online platform and can also make a new payment.
O. My Ratings: In this section a performer views the list of ratings he got on his performance in any event.
P. Real Time Notifications: System will generate real time notifications for the following:
   a. New Message in the Inbox
   b. Venue's action on any performance request.
   c. Any Invitation sent to him by venue to perform in an event.
   d. Any action is performed regarding Trading Requests
   e. Performer receive Host Request by the Venue
   f. Time slot changed for any event
   g. Registered event is going to happen today
Q. Email Notifications:
   a. New Message in the Inbox
   b. Venue's action on any performance request.
   c. Any Invitation sent to him by venue to perform in an event.
   d. Any action is performed regarding Trading Requests
   e. Performer receive Host Request by the Venue
   f. Display Picture Missing
   g. Time slot changed for any event
   h. Registered event is going to happen today
R. Help Page
S. Settings
   a. Turn On/Off Email notifications
   b. Turn On/Off receiving On-site messages
T. Site-wise Option Description Added (Show Option Description on “?”)

### Admin Panel:

This role performs the following actions:
A. Performers:
   a. View List
   b. Suspend Performer
   c. Activate Performer
B. Venue
   a. View List
   b. Suspend Venue
   c. Activate Venue
C. Events
   d. View List
   e. Edit Event

The present online event management platform provides a common platform for an owner of a venue, an event organizer, a performer and an event attendee to create an event, advertise the event and participate in the event. The present online platform also provide a ranking system for the performers which allows a local performer to gain fame by improving his or her ranking and receive more performance opportunities on the basis of the ranking

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims.

I claim:

1. A method for an online event management platform with a real time performer and attendance management provided to a venue of an event, the method comprises:
creating a profile on the online event management platform;
linking at-least one networking website to the created profile, wherein the venue log into the online platform directly through a newly created login ID and password or through the linked networking website;
creating a specific uniform resource locator (URL) for the created profile;
managing a date and time of an event over the specific URL;
sending an invitation to a plurality of performers and performance attendees through the online platform and the at-least one linked networking website, wherein the venue also manages a request received from a performer to perform at an event;
blocking a time slot, the performers and the attendees for an event prior to a commencement of the event;
receiving real time notification of an event, wherein the real time notification comprises a message in an inbox, a performer's action in reply to a sent invitation, an application from a performer for an event, a pending ranking notification and an attendee action over an invitation or request to join the event.

2. The method according to claim 1, wherein the venue manages the created profile over the online platform, wherein the online platform works over a system comprising:
a primary computing device, wherein the primary computing device is implemented to create an event;
a central server, wherein the central server is a remote hosting device further comprising:
a memory unit, wherein the memory unit holds a plurality of profile data and a plurality of event data;
an analytical module, wherein the analytical module manages invitations sent in the event, timing of the event and a list of attendees and performers;
a notification segregator, wherein the notification segregator stores and transmits a real time notification as well as segregates a notification in various categories;
a plurality of secondary computing devices, wherein the plurality of secondary computing devices are connected to the central server, wherein the attendees accept an invitation or send a request for the event through the plurality of the computing devices.

3. The method according to claim 1, wherein a plurality of event styles are selected by the venue, wherein the plurality of event styles comprises a cultural event, a historical event, a national event, a concert and a gaming event.

4. The method according to claim 1, wherein the central server marks an attendance in an event and ranks a performer on the basis of a response of the attendees.

5. A method for an online event management platform with a real time attendance and venue management provided to a performer of an event, the method comprises:
creating a profile on the online event management platform;
linking at-least one networking website to the created profile, wherein the venue log into the online platform directly through a newly created login ID and password or through the linked networking website;
creating a specific uniform resource locator (URL) for the created profile;
managing a date and time of an event over the specific URL;
sending a request to a venue for participating in an event or organizing an event, wherein the venue manages the request received from the performer as well as a list of attendees;
blocking a time slot, the performers and the attendees for an event prior to a commencement of the event;
receiving real time notification of an event, wherein the real time notification comprises a message in an inbox, a performer's action in reply to a sent invitation, an application from a performer for an event, a ranking notification, a trading status, a time slot change for an event and an attendee action over an invitation or request to join the event.

6. The method according to claim 5, wherein the venue manages the created profile over the online platform, wherein the online platform works over a system comprising:
a primary computing device, wherein the primary computing device is implemented to create an event;
a central server, wherein the central server is a remote hosting device further comprising:
a memory unit, wherein the memory unit holds a plurality of profile data and a plurality of event data;
an analytical module, wherein the analytical module manages invitations sent in the event, timing of the event and a list of attendees and performers;
a notification segregator, wherein the notification segregator stores and transmits a real time notification as well as segregates a notification in various categories;
a plurality of secondary computing devices, wherein the plurality of secondary computing devices are connected to the central server, wherein the attendees accept an invitation or send a request for the event through the plurality of the computing devices.

7. The method according to claim 5, wherein the performer manages a trading request received from or sent to a plurality of performers through the online platform.

8. The method according to claim 5, wherein the central server marks an attendance in an event and ranks the performer on the basis of a response of the attendees.
